(19) United States
(12) Patent Application Publication
(10) Pub. No.: US 2023/0172156 A1
(43) Pub. Date: Jun. 8, 2023

(54) portable inflatable pet nest

(71) Applicant: Zhongshan Great-pet internationl Co., LTD, Zhongshan (CN)

(72) Inventor: Yin Lin, Zhongshan (CN)

(21) Appl. No.: 17/646,285

(22) Filed: Dec. 28, 2021

(30) Foreign Application Priority Data
Dec. 7, 2021 (CN) 202123063764.X

(51) Int. Cl. A01K 1/03

(52) U.S. Cl. CPC A01K 1/03

(57) ABSTRACT

A portable inflatable pet nest includes an airbag, forming a pet nest after inflation, an interior of the pet nest is provided with a cavity, an out wall of the airbag is provided with an exit and entrance communicating with the cavity, and charging and discharging interfaces. In being used, an air pump is connected with the charging and discharging interfaces and inflates to the airbag, the airbag forms the pet nest after it is inflated, the cavity in the pet nest can be used for the pet to rest. When not be used, the charging and discharging interfaces are opened, the air in the airbag is released so that the airbag can be folded. The portable inflatable pet nest occupies a small space, it is convenient to store and transport, and the transportation cost is greatly reduced.

### FIELD OF THE INVENTION

The present invention relates to pet nest technical field, more particularly, relates to a portable inflatable pet nest.

### BACKGROUND OF THE INVENTION

As the improvement of living standards, more and more families feed cats and dogs in spare time. As a lifestyle of leisure and entertainment, the owner will enjoy with the company of the pet. Pet nest is an essential product for the pet.

Most of the existing pet nests are made of cotton, plastic, wood, etc. The structure of the pet nests can not be changed. When the pet nests are not using, they occupy large spaces, it is not convenient to store and transport, and the transportation cost is increased.

### SUMMARY OF THE INVENTION

The object of the present invention is to provide a portable inflatable pet nest, aiming to solve the technical problems that when the pet nests in the prior art are not used, it occupy large space, it is not convenient to store and transport, and the transportation cost is increased.

To achieve the above object, the present invention provides a portable inflatable pet nest, which includes an airbag, forming a pet nest after inflation. The interior of the pet nest is provided with a cavity, an out wall of the airbag is provided with exit and entrance communicating with the cavity and charging and discharging interfaces.

Optionally, the airbag includes a base and a wall around an edge of the base, and a cover on a top of the wall; the base, the wall and the cover are enclosed to form the cavity the exit and entrance are arranged on the wall.

Optionally, a periphery of the cover extends out of the wall.

Optionally, the cover is conical.

Optionally, the base, the wall and the cover are communicated with each other, the charging and discharging interfaces are arranged on the base, the wall or the cover.

Optionally, a top surface of the base is provided with a groove.

Optionally, a bottom surface of the base is uniformly provided with a plurality of anti-slip pads.

Optionally, the surface of the airbag covers with a protecting layer.

Optionally, the protecting layer is made of oxford cloth, nylon cloth, polyester cloth, polypropylene cloth or PVC cloth.

Optionally, the airbag is provided with a handle.

Compared with the prior art, one or more of the above technical schemes about the portable inflatable pet nests provided in embodiments of the present invention have at least one of the following technical effects:

In being used, an air pump is connected with the charging and discharging interfaces and inflates to the airbag, the airbag forms the pet nest after it is inflated, the cavity in the pet nest can be used for the pet to rest. When not be used, the charging and discharging interfaces are opened, the air in the airbag is released so that the airbag can be folded. The portable inflatable pet nest occupies a small space, it is convenient to store and transport, and the transportation cost is greatly reduced.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is a perspective view of the portable inflatable pet nest in the embodiment according to the present invention.

FIG. 2 is a sectional view of the portable inflatable pet nest in the embodiment according to the present invention.

### DETAILED DESCRIPTION OF ILLUSTRATED EMBODIMENTS

In order to make the invention purpose, the technical scheme and the technical effect more clearly be understood, the invention is further explained in combination with the concrete embodiment below. It should be understood that the specific embodiments described herein are only used to interpret the invention, and are not used to limit the invention.

Embodiments of the present invention are described in detail below, and examples of the embodiments are shown, in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limits.

In the embodiments of the invention, unless otherwise clearly specified and defined, the terms, “installed” “connected”, “or” fixed” should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, the specific meaning of the above terms in the embodiment of the present invention may be understood under specific circumstances.

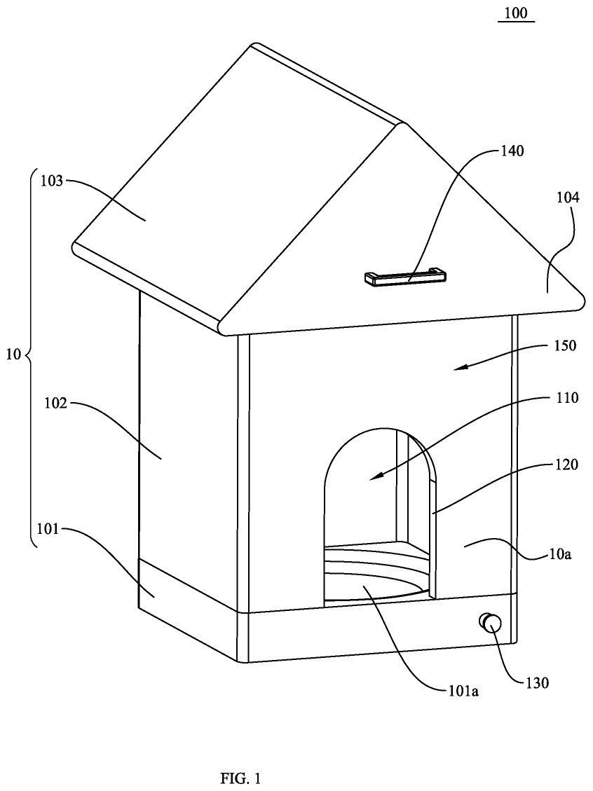

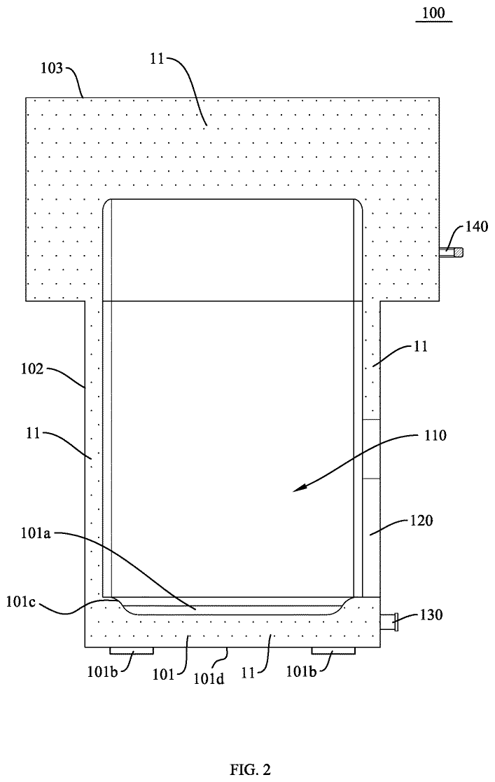

In an embodiment according to the present invention, referring to FIG. 1 and FIG. 2, the portable inflatable pet nest includes an airbag 10 with a sealing chamber 11.

Referring to FIG. 1 and FIG. 2, the airbag 10 foul's a pet nest 100 after the sealed chamber 11 is inflated. The interior of the pet nest 100 is provided with a cavity 110, an out wall of the airbag 10 is provided with an exit and entrance 120 communicating with the cavity 110. Pets can enter the cavity 110 through the exit and entrance 120. The out wall of the airbag 10 is provided with at least one charging and discharging interface 130 communicating with the sealing chamber 11.

Compared with the prior art, the portable inflatable pet nest provided in embodiments of the present invention has at least one of the following technical effects:

Referring to FIG. 1 and FIG. 2, in being used, an air pump is connected with the charging and discharging interfaces 130 and inflates to the airbag 10, the airbag 10 forms the pet nest 100 after it is inflated, the cavity 110 in the pet nest 100 can be used for the pet to rest. When not being used, the charging and discharging interfaces 130 are opened, the air in the sealing chamber 11 of the airbag 10 is released so that the airbag 10 can be folded. The portable inflatable pet nest occupies a small space, it is convenient to store and transport, and the transportation cost is greatly reduced.

In an embodiment according to the present invention, referring to FIG. 1 and FIG. 2, the airbag 10 includes a base 101 and a wall 102 around an edge of the base 101, and a cover 103 on a top of the wall 102. The base 101, the wall 102 and the cover 103 are enclosed to form the cavity 110, the exit and entrance 120 are arranged on the wall 102.

Specifically, referring to FIG. 1 and FIG. 2, the cover 103 has the function of blocking the sun and the rain. The wall 102 and the base 101 are also waterproof, so that the pet nest 100 can be used indoors or outdoors. When be used indoors, the cover 103 and the base 102 can block the sun and the rain, the cavity 110 has a darker environment, which is benefit for pet sleeping. When be used outdoors, the cover 103 and the wall 102 can block the sun and the rain, thereby preventing the pet from sun exposure or rain.

Referring to FIG. 1 and FIG. 2, the periphery of the cover 103 extends out of the wall 102 to form an eaves structure 104, which is conducive to shielding the cover 103 from sunlight and rain.

Further, referring to FIG. 1 and FIG. 2, the cover 103 is conical, which is similar to a shape of a roof. When it rains in outdoor use, it is conducive to the drainage of the cover 103 and avoid ponding.

In an embodiment according to the present invention, referring to FIG. 1 and FIG. 2, the base 101, the wall 102 and the cover 103 are communicated with each other, the charging and discharging interfaces 130 are arranged on the base 101, the wall 102 or the cover 103. An air pump is connected with the charging and discharging interfaces 130 and inflates to the sealed chamber 11 of the airbag 10, the base 101, the wall 102 and the cover 103 can be full of air. The structure of the portable inflatable pet nest is simple and the operation is convenient.

In some embodiments, the base 101, the wall 102 and the cover 103 are mutually independent structures, that is to say all of the base 101, the wall 102 and the cover 103 have a independent air cavity, all of the out wall of the base 101, that of the wall 102 and that of the cover 103 are provided with a charging and discharging interface 130, respectively. In being used, it needs to inflate to the base 101, the wall 102 and the cover 103, respectively.

In an embodiment according to the present invention, referring to FIG. 1 and FIG. 2, the top surface 101c of the base 101 is provided with a groove 101a. When the pet rests in the groove 101a, the the groove 101a fully supports the pet to enhance its comfort.

Further, referring to FIG. 1 and FIG. 2, the bottom surface 101d of the base 101 is uniformly provided with a plurality of anti-slip pads 101b. The base 101 contacts with ground through the anti-slip pads 101b, which increase the friction force between the base 101 and the ground so that the base 101 can stably placed on the ground.

In an embodiment according to the present invention, referring to FIG. 1 and FIG. 2, the surface of the airbag covers with a protecting layer 150, which is used for protecting the airbag and preventing the pet from scratching the airbag 10.

The protecting layer 150 covers the surface 10a of the airbag 10 by bonding, welding, etc.

Further, the protecting layer 150 is made of oxford cloth, nylon cloth, polyester cloth, polypropylene cloth or PVC cloth. These material has excellent tensile, wear resistance and peeling resistance, so that the protective layer 150 can well protect the airbag 10 from being scratched by pets.

In an embodiment according to the present invention, referring to FIG. 1 and FIG. 2, the airbag 10 is provided with a handle 140, which is convenient for the users to carry the airbag 10 or the pet nest 100.

What is claimed is:

1. The portable inflatable pet nest, wherein comprising an airbag, forming a pet nest after inflation, an interior of the pet nest is provided with a cavity, an out wall of the airbag is provided with an exit and entrance communicating with the cavity, and charging and discharging interfaces.

2. The portable inflatable pet nest according to claim 1, wherein the airbag includes a base and a wall around an edge of the base, and a cover on a top of the wall; the base, the wall and the cover are enclosed to form the cavity, the exit and entrance is arranged on the wall.

3. The portable inflatable pet nest according to claim 2, wherein a periphery of the cover extends out of the wall.

4. The portable inflatable pet nest according to claim 2, wherein the cover is conical.

5. The portable inflatable pet nest according to claim 2, wherein the base, the wall and the cover are communicated with each other, the charging and discharging interfaces are arranged on the base, the wall or the cover.

6. The portable inflatable pet nest according to claim 2, wherein the top surface of the base is provided with a groove.

7. The portable inflatable pet nest according to claim 2, wherein the bottom surface of the base is uniformly provided with a plurality of anti-slip pads.

8. The portable inflatable pet nest according to claim 1, wherein the surface of the airbag covers with a protecting layer.

9. The portable inflatable pet nest according to claim 8, wherein the protecting layer is made of oxford cloth, nylon cloth, polyester cloth, polypropylene cloth or PVC cloth.

10. The portable inflatable pet nest according, to claim 1, wherein the airbag is provided with a handle.
